(19) United States
(12) Patent Application Publication
(10) Pub. No.: US 2004/0001745 A1
(43) Pub. Date: Jan. 1, 2004

(54) Fastener assembly having rotation preventing structure

(76) Inventor: Jinn Shing Chen, Taichung (TW)

Correspondence Address: Jinn Shing Chen, P.O. Box 63-298, Taichung, 406, TW

(21) Appl. No.: 10/184,951

(22) Filed: Jul. 1, 2002

(51) Int. Cl. F16B 37/04

(52) U.S. Cl. 411/182

(57) ABSTRACT

A fastener assembly includes a lock nut secured to an object, and a screw engaged through the other objects and threaded to the lock nut for securing the objects together. The lock nut includes a peripheral flap extended from one end of a tubular member and engaged with the object, and one or more ribs engaged into the object, for preventing the lock nut from rotating relative to the objects. The screw may thus solidly engage with the lock nut. The other end of the lock nut is machined radially outward to engage with the object, and to secure the ribs in the object.

### BACKGROUND OF THE INVENTION

1. Field of the Invention

The present invention relates to a fastener assembly, and more particularly to a fastener assembly having a structure for solidly securing two or more objects together and for preventing the screw and the lock nut from rotating relative to each other.

2. Description of the Prior Art

Typical fasteners or bolts or screws may comprise one or more lips or wedges or ribs provided between the head and the body, for engaging into the objects to be clamped. U.S. Pat. No. 400,161 to Balston, U.S. Pat. No. 4,764,066 to Terrell et al., and U.S. Pat. No. 5,746,560 to Barth et al., disclose three of the typical bolts or screws. However, though the lips or wedges or ribs provided between the head and the body may be engaged into the objects to be clamped, the lips or wedges or ribs may also be disengaged from the objects when the bolts or screws are rotated or driven relative to the objects by wrenches or the like. Particularly, the wedge shaped ribs or lips may force the bolts or screws to be moved away or disengaged from the objects when the bolts or screws are rotated relative to the objects by wrenches or the like.

U.S. Pat. No. 6,220,804 to Pamer et al. discloses another typical fastener or nut also having one or more lips or wedges or ribs provided between the nut body and a cylindrical member, for engaging into the objects to be clamped. Similarly, the lips or wedges or ribs may also be disengaged from the objects when the nuts are rotated or driven relative to the objects by wrenches or screws or the like. Particularly, the wedge shaped ribs or lips may force the nuts to be moved away or disengaged from the objects when the nuts are rotated relative to the objects by wrenches or screws or the like.

U.S. Pat. No. 4,911,592 to Muller discloses a further typical fastener or nut also having one or more ribs provided between the nut body and a cylindrical member, for engaging into the objects to be clamped. Similarly, the lips or wedges or ribs may also be disengaged from the objects when the nuts are rotated or driven relative to the objects by wrenches or screws or the like. Particularly, the wedge shaped ribs may force the nuts to be moved away or disengaged from the objects when the nuts are rotated relative to the objects by wrenches or screws or the like.

The present invention has arisen to mitigate and/or obviate the afore-described disadvantages of the conventional fastener assemblies.

### SUMMARY OF THE INVENTION

The primary objective of the present invention is to provide a fastener assembly including a structure for solidly securing two or more objects together and for preventing the screw and the lock nut from rotating relative to each other.

In accordance with one aspect of the invention, there is provided a fastener assembly comprising a first object including a hole formed therein, a lock nut including a tubular body engaged in the hole of the first object and having a first end and a second end, and including a peripheral flap extended radially from the first end of the tubular body and engaged with the first object, and including at least one rib abridging an angular junction between the tubular body and -the peripheral flap and engaged into the first object, for securing the lock nut to the first object, and for preventing the lock nut from rotating relative to the first object, the first end of the lock nut including a bore formed therein and an inner thread formed in the bore thereof, the second end of the lock nut being extended out of the hole of the first object and machined radially and outwardly to engage with the first object, and to solidly secure the rib in the first object, and to prevent the rib from being disengaged from the first object, at least one second object engaged onto the first object, and a screw engaged through the second object and engaged into the bore of the tubular body and threaded with the inner thread of the tubular body, for solidly securing the first object and the second object together.

The second end of the lock nut includes a peripheral bead or one or more peripheral ears extended radially and outwardly to engage with the first object, and to solidly secure the rib in the first object, and to prevent the rib from being disengaged from the first object.

The second end of the lock nut includes an opening formed therein and having an inner diameter smaller than that of the bore of the tubular body, for forming a peripheral shoulder between the bore and the opening of the tubular body.

The rib includes a pyramidal projection having a portion integral with the peripheral flap, and another portion integral with the tubular body, and having an inclined ridge for engaging into the first object.

The rib may alternatively include a triangular base having a portion integral with the peripheral flap, and another portion integral with the tubular body, and having a cusp parallel to the -tubular body and perpendicular to the peripheral flap, and a pyramidal projection extended from the base and having an inclined ridge for engaging into the first object.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a fastener assembly in accordance with the present invention;

FIGS. 2, 3 are exploded views illustrating the securing of two objects with the fastener assembly;

FIG. 4 is a perspective view of a lock nut of the fastener assembly;

FIG. 5 is a perspective view similar to FIG. 4, illustrating the operation of the lock nut of the fastener assembly;

FIG. 6 is a partial cross sectional view illustrating the securing of two objects with the fastener assembly;

FIGS. 7, 8 are cross sectional views taken along lines 7-7 and 8-8 of FIG. 6 respectively;

FIG. 9 is an exploded view similar to FIG. 1, illustrating the other embodiment of the fastener assembly;

FIGS. 10, 11 are perspective views similar to FIGS. 4 and 5 respectively, illustrating the operation of the lock nut as shown in FIG. 9;

FIGS. 12, 13 are exploded views illustrating the securing of two objects with the fastener assembly as shown in FIGS. 9-11;

FIG. 14 is a partial cross sectional view illustrating the securing of two objects with the fastener assembly as shown in FIGS. 9-13; and

FIGS. 15, 16 are cross sectional views taken along lines 15-15 and 16-16 of FIG. 14 respectively.

### DETAILED DESCRIPTION OF THE PREFERRED EMBODIMENT

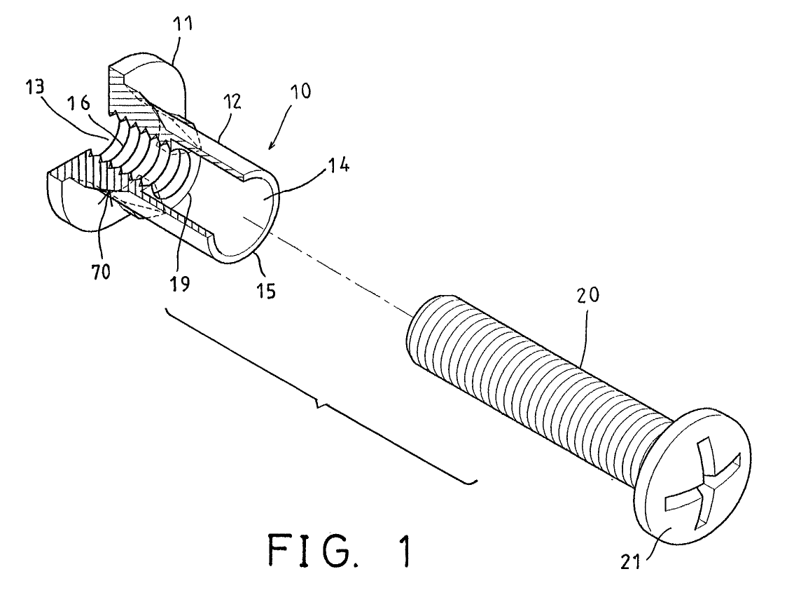

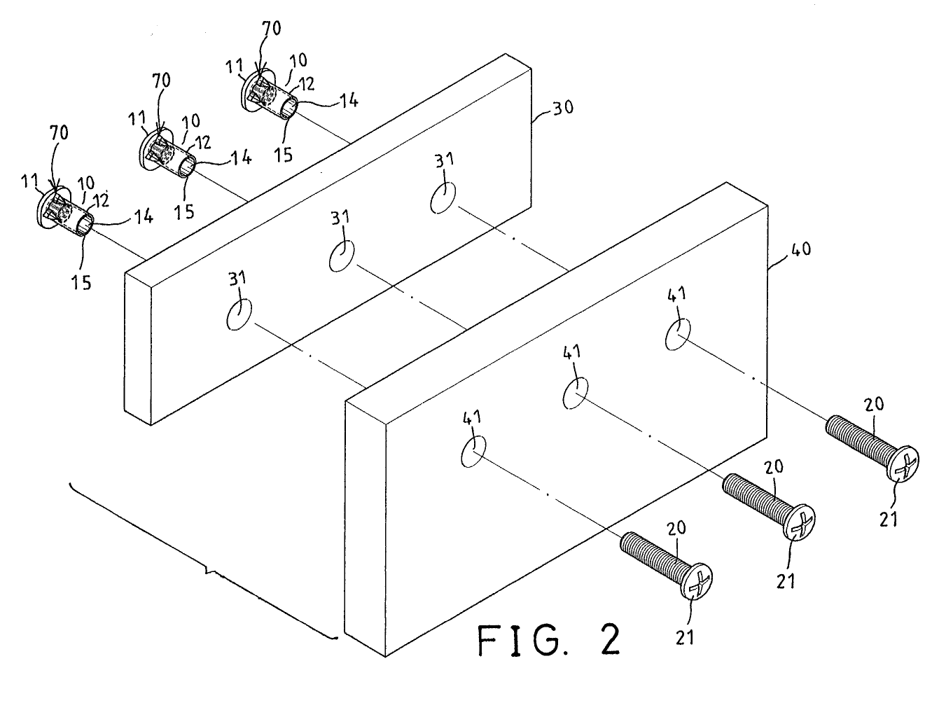

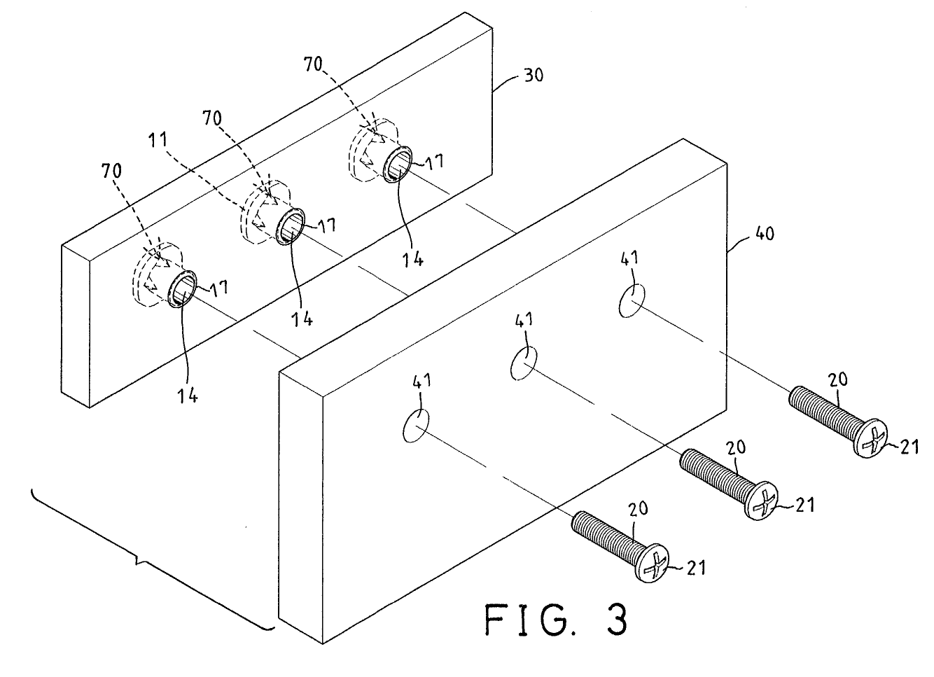

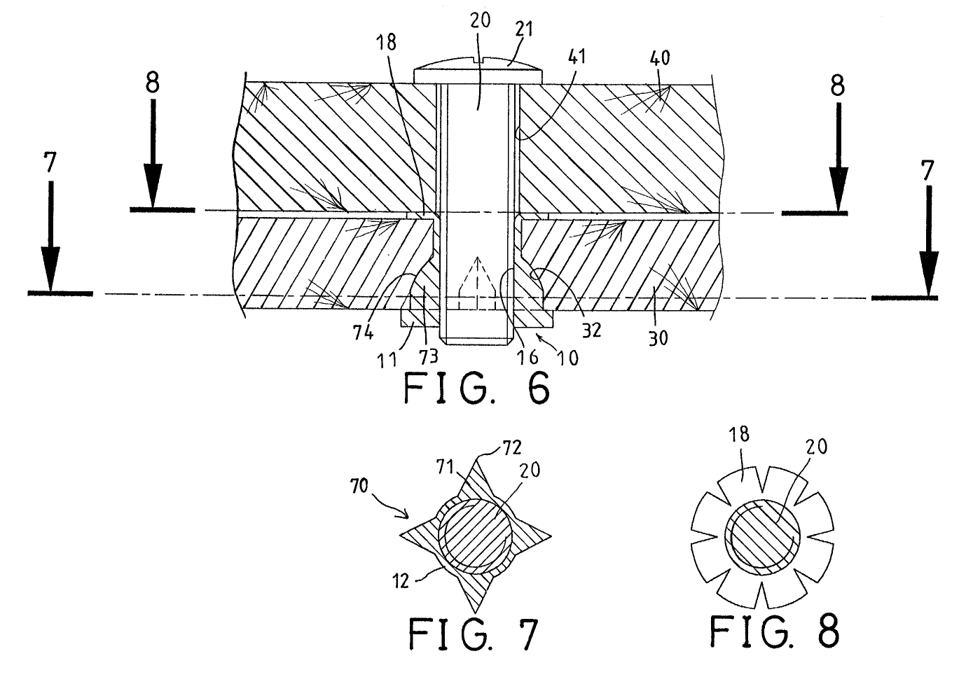

Referring to the drawings, and initially to FIGS. 1-8, a fastener assembly in accordance with the present invention comprises a lock nut 10 for engaging into and securing to a hole 31 of an object 30, and a screw 20 engaged through a hole 41 of one or more other objects 40 and threaded to the lock nut 10 for securing the objects 30, 40 together (FIGS. 3, 4, 6).

The objects 30, 40 may be made of plastic or metal materials (FIG. 6), or the other synthetic materials, but may also be made of wood materials, as shown in FIG. 14.

The lock nut 10 includes a peripheral flap 11 laterally or radially extended outward from one end of a cylindrical or tubular body 12, for engaging with the object 30, and for solidly securing the lock nut 10 to the object 30.

The screw 20 includes an enlarged head 21 for engaging with the other object 40, and for allowing the objects 30, 40 to be solidly secured between the peripheral flap 11 of the lock nut 10 and the enlarged head 21 of the screw 20, best shown in FIG. 6.

The tubular body 12 may be snugly engaged in the hole 31 of the object 30, and includes a bore 13 formed in one end thereof, close to the peripheral flap 11, and includes an inner thread 16 formed in the bore 13 thereof for threading with the screw 20.

The tubular body 12 further includes an opening 14 formed in the other end 15 thereof, distal to the peripheral flap 11, and having an inner diameter greater than that of the bore 13 thereof, for forming or defining a peripheral shoulder 19 between the bore 13 and the opening 14 thereof.

The other end 15 of the tubular body 12 is partially extended out of the hole 31 of the object 30, and may be machined or hammered or forged or expanded radially and outwardly to form a peripheral bead 17 (FIGS. 3, 4, 5, 10) and to engage with the object 30, and to solidly secure the lock nut 10 to the object 30 (FIG. 3).

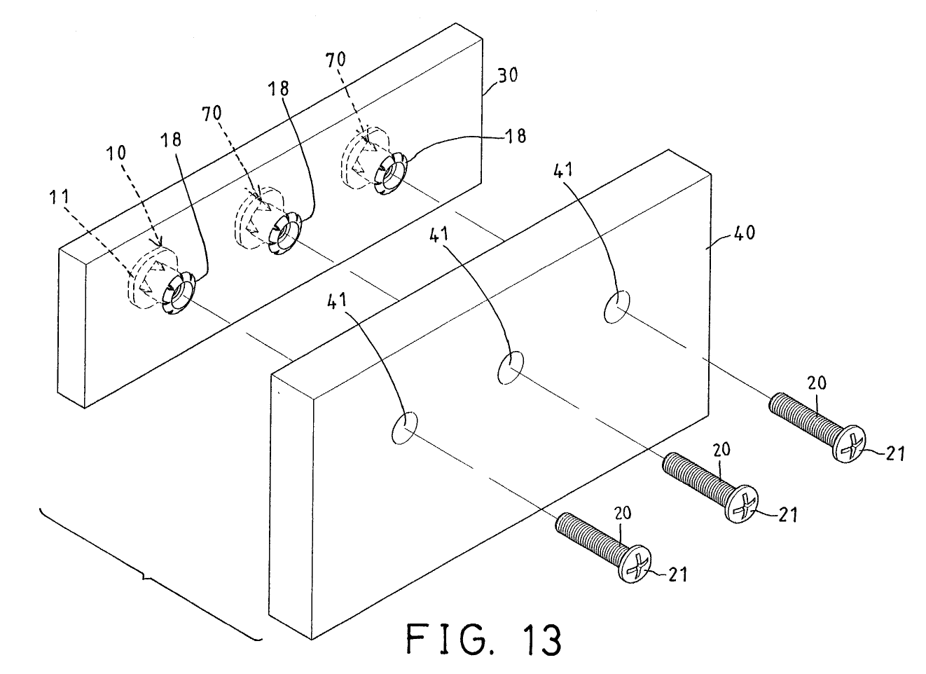

Alternatively, the other end 15 of the tubular body 12 that is partially extended out of the hole 31 of the object 30 may also be hammered or forged or expanded radially and outwardly to form a number of radially extended ears 18 (FIGS. 5, 8, 11, 13, 16) and to engage with the object 30, and to solidly secure the lock nut 10 to the object 30 (FIGS. 6, 13, 14).

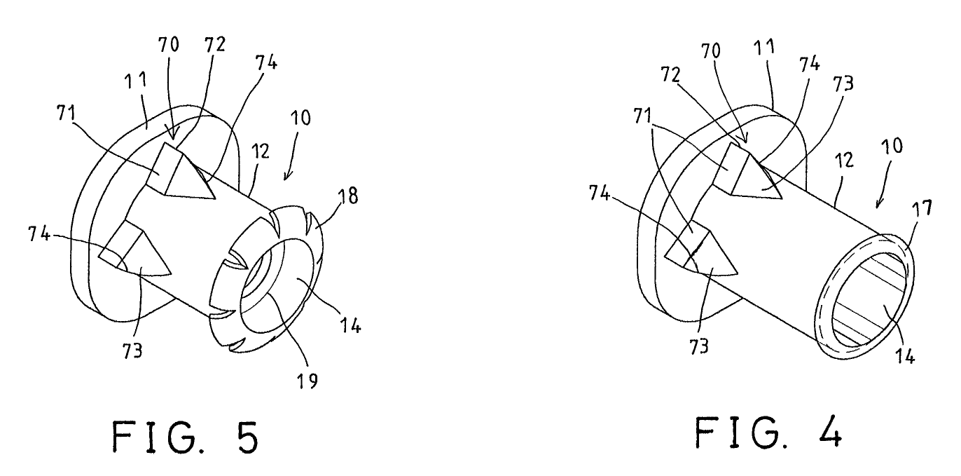

As best shown in FIGS. 4-7, the lock nut 10 includes a number of ribs 70 abridging the angular junction between the peripheral flap 11 and the tubular body 12. The ribs 70 each includes a triangular base 71 having a portion integral with the peripheral flap 11 and the other portion integral with the tubular body 12, and having a cusp 72 parallel to the tubular body 12 and perpendicular to the peripheral flap 11.

The ribs 70 each further includes a pyramidal projection 73 extended therefrom or extended or facing away from the peripheral flange 11, and having a portion integral with the base 71 and the other portion integral with the tubular body 12.

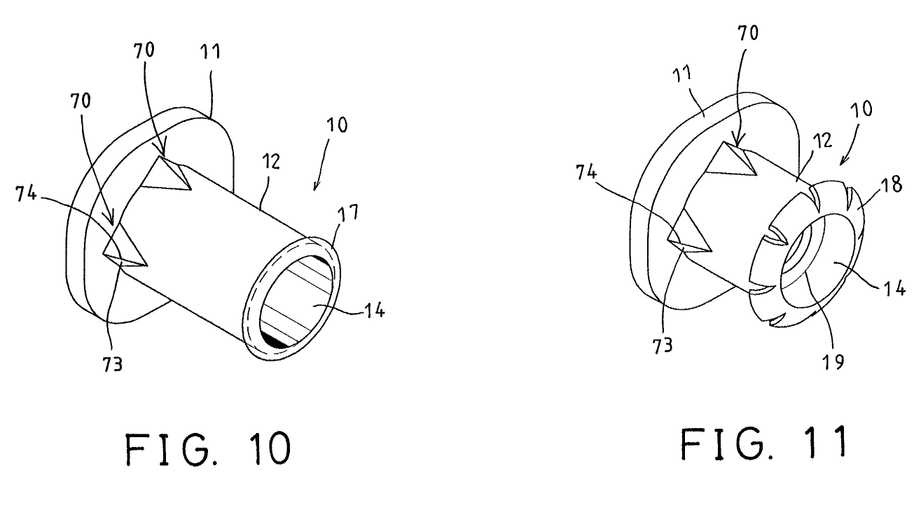

The pyramidal projections 73 each includes an inclined (FIGS. 10, 11, 14) and/or curved (FIGS. 4-6) ridge 74 inclined from the base 71 toward the tubular body 12, for forcing or engaging into a peripheral space 32 of the object 30 (FIGS. 6, 14), and for allowing the ribs 70 to be solidly engaged in the peripheral space 32 of the object 30. The peripheral space 32 and the hole 31 of the object 30 are comunicating with each other.

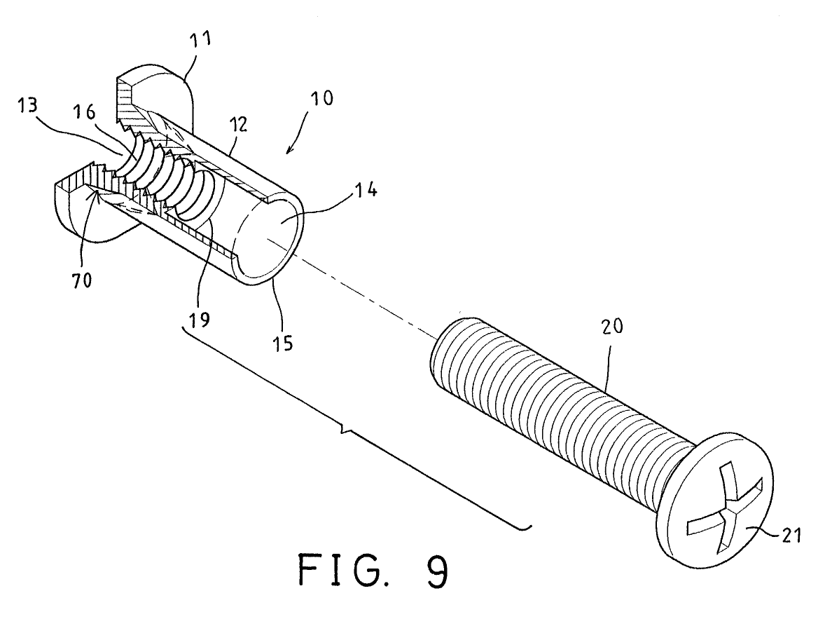

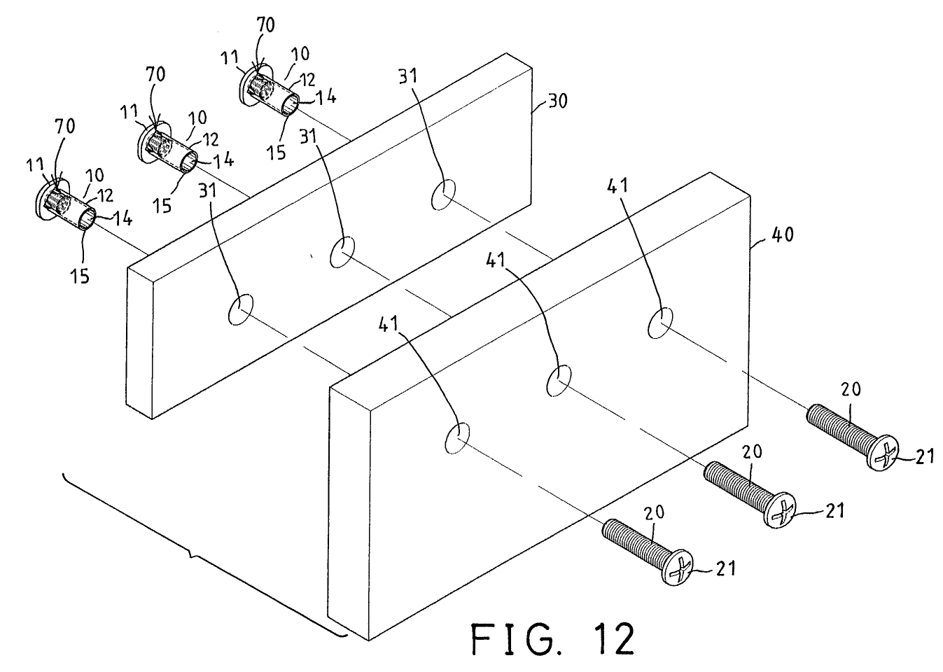

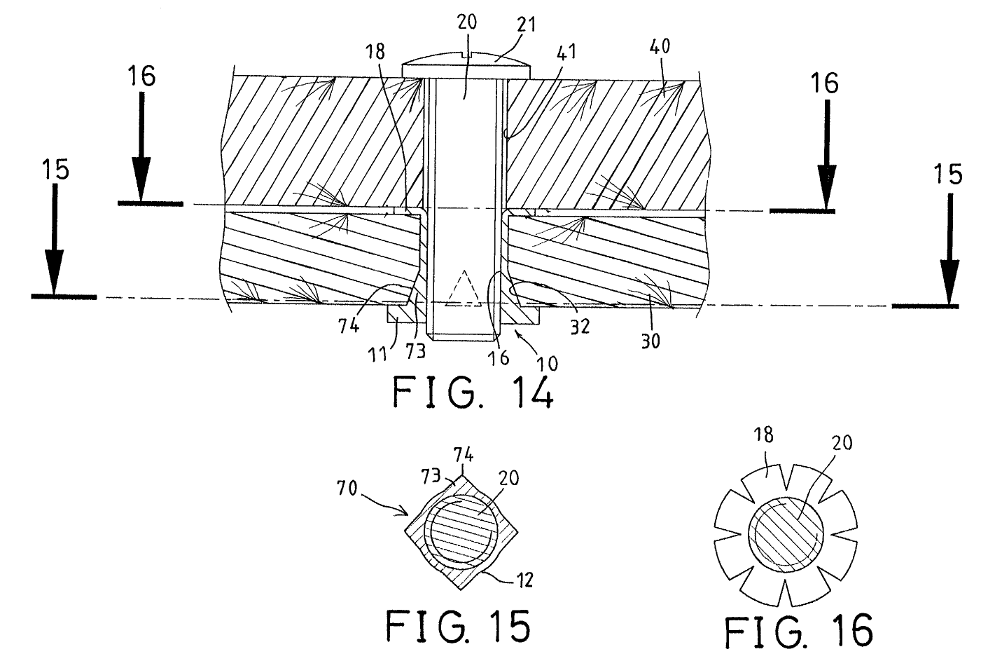

Alternatively, as shown in FIGS. 9-15, the ribs 70 may each include a pyramidal projection 73 only, without the triangular base 71. The pyramidal projections 73 may also be engaged into the peripheral space 32 of the object 30.

In operation, as shown in FIGS. 6 and 14, the triangular base 71 and/or the pyramidal projections 73 of the ribs 70 may be forced and engaged into the peripheral space 32 of the object 30. In addition, the other end 15 of the tubular body 12 is partially extended out of the hole 31 of the object 30, and may be hammered or forged or expanded radially and outwardly to form a peripheral bead 17 or a number of ears 18 and to engage with the object 30, and to retain the engagement of the triangular base 71 and/or the pyramidal projections 73 of the ribs 70 in the peripheral space 32 of the object 30 and to prevent the ribs 70 from being disengaged from the object 30, and thus to solidly secure the lock nut 10 to the object 30.

The engagement of the triangular base 71 and/or the pyramidal projections 73 of the ribs 70 in the peripheral space 32 of the object 30 may prevent the lock nut 10 from being rotated relative to the object 30, such that the screw 20 may be solidly threaded with and secured to the lock nut 10.

Particularly, the engagement of the triangular base 71 of the ribs 70 in the peripheral space 32 of the object 30 may prevent the lock nut 10 from being rotated relative to the object 30, for allowing the screw 20 to be solidly threaded with and secured to the lock nut 10.

Accordingly, the fastener assembly in accordance with the present invention includes a structure for solidly securing two or more objects together and for preventing the screw and the lock nut from rotating relative to each other.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fastener assembly comprising:
a first object including a hole formed therein, a lock nut including a tubular body engaged in said hole of said first object and having a first end and a second end, and including a peripheral flap extended radially from said first end of said tubular body and engaged with said first object, and including at least one rib abridging an angular junction between said tubular body and said peripheral flap and engaged into said first object, for securing said lock nut to said first object, and for preventing said lock nut from rotating relative to said first object,
said first end of said lock nut including a bore formed therein and an inner thread formed in said bore thereof,
said second end of said lock nut being extended out of said hole of said first object and machined radially and outwardly to engage with said first object, and to solidly secure said at least one rib in said first object, and to prevent said at least one rib from being disengaged from said first object,
at least one second object engaged onto said first object, and
a screw engaged through said at least one second object and engaged into said bore of said tubular body and threaded with said inner thread of said tubular body, for solidly securing said first object and said at least one second object together.

2. The fastener assembly according to claim 1, wherein said second end of said lock nut includes a peripheral bead extended radially and outwardly to engage with said first object, and to solidly secure said at least one rib in said first object, and to prevent said at least one rib from being disengaged from said first object.

3. The fastener assembly according to claim 1, wherein said second end of said lock nut includes a plurality of peripheral ears extended radially and outwardly to engage with said first object, and to solidly secure said at least one rib in said first object, and to prevent said at least one rib from being disengaged from said first object.

4. The fastener assembly according to claim 1, wherein said second end of said lock nut includes an opening formed therein and having an inner diameter smaller than that of said bore of said tubular body, for forming a peripheral shoulder between said bore and said opening of said tubular body.

5. The fastener assembly according to claim 1, wherein said at least one rib includes a pyramidal projection having a portion integral with said peripheral flap, and another portion integral with said tubular body, and having an inclined ridge for engaging into said first object.

6. The fastener assembly according to claim 1, wherein said at least one rib includes a triangular base having a portion integral with said peripheral flap, and another portion integral with said tubular body, and having a cusp parallel to said tubular body and perpendicular to said peripheral flap, and a pyramidal projection extended from said base and having an inclined ridge for engaging into said first object.

7. The fastener assembly according to claim 6, wherein said inclined ridge of said pyramidal projection is curved.
